(19) United States
(12) Patent Application Publication
(10) Pub. No.: US 2013/0219425 A1
(43) Pub. Date: Aug. 22, 2013

(54) METHOD AND APPARATUS FOR STREAMING ADVERTISEMENTS CONCURRENTLY WITH REQUESTED VIDEO

(71) Applicant: Gary I. Swartz, Delta (CA)

(72) Inventor: Gary I. Swartz, Delta (CA)

(73) Assignee: EYEDESTINATIONS INC., Thornhill (CA)

(21) Appl. No.: 13/398,730

(22) Filed: Feb. 16, 2012

(51) Int. Cl. H04N 21/458

(52) U.S. Cl. 725/32

(57) ABSTRACT

Roughly described, a server, accessible by a requesting device via a network, includes a database storing a plurality of composite video assets each having pictures to be displayed in sequence. Each of the pictures in the asset has first and second rectangular regions, which are adjacent to each other along a common edge. A primary movie is carried in the first rectangular region while the second rectangular region carries a plurality of temporally-arranged advertising images. The advertising images do not overlap, intrude on or distort the primary movie, but rather expand the canvas on which both image sequences appear. The images in the first and second rectangular regions are spatially composited together in each picture as single, unitary pictures prior to streaming transmission toward the user's device, so that no second concurrent stream is required. Several methods to develop the composite assets are described.

### FIELD OF THE INVENTION

The invention relates to streaming video transmission, and more particularly to combining a primary video with a secondary image or set of images on behalf of a third party, such as an advertiser.

### BACKGROUND

Present day mobile devices such as mobile phones, with their small screens, finite power supplies, and the lower parameters of their graphics controllers, CPUs and operating systems, are typically limited to a displaying a single video stream and, in many cases, are not capable of displaying overlays such as are available for Flash(R) videos to be displayed on personal computers. Nor are they usually capable of handling other methods, such as banner advertisement adjacent or close to streaming video images on a web page, such as is often used to display advertising concurrent with a video stream on a webpage displayed on a personal computer.

As a result the viable options for the effective delivery of advertising in conjunction with streaming video to mobile devices are limited. Traditional banners can be displayed on menu pages, for example, but these may not be on screen for long and may be difficult to read if they are also intended for a personal computer. Another available option is to play advertising as pre-roll videos, mid-roll videos or post-roll videos, all of which have significant drawbacks including a propensity by users to click away during the ad. The cost to produce such advertising videos is also high, as often they are either original productions or adaptations of commercials produced for television or theatres. Overlays have also been a viable option in the past, but the most prevalent software that enabled overlays is no longer being developed and in any case could not be used with many leading operating systems.

Advertising is an important part of many revenue models that enable the delivery of streaming video to users, and the limited options for advertisers to support video destined primarily for mobile devices constrains growth in that area. The more effective the advertising, and the greater the number of platforms on which it can be displayed, and the lower the cost of producing it, the greater will be the willingness of advertisers to underwrite the cost of video delivery and the richer and more varied the viewing experiences will be for users. Thus there is an opportunity for an advertising delivery platform developed primarily to meet the limitations of mobile devices, that overcomes some or all of the above problems, and that is better able to meet the needs and expectations of advertisers and users.

### SUMMARY

Roughly described, the invention involves a server, accessible by a requesting device via a network, which includes a database storing a plurality of composite video assets each having pictures to be displayed in sequence. Each of the pictures in the asset has first and second rectangular regions, which are adjacent to each other along a common edge. A primary movie is carried in the first rectangular region while the second rectangular region carries a plurality of temporally-arranged advertising images. The advertising images do not overlap, intrude on or distort the primary movie, but rather expand the canvas on which both image sequences appear. The images in the first and second rectangular regions are spatially composited together in each picture as single, unitary pictures prior to streaming transmission toward the user's device, so that no second concurrent stream is required. Several methods to develop the composite assets are described.

In an embodiment, the primary video has a standard aspect ratio such as 16:9, and an adtrack, which is stacked above or below the primary video, has an aspect ratio such as 16:1.5. It has been recognized that the typical screens on many of the most popular mobile devices, especially mobile phones, have aspect ratios that ranges from slightly over 16:9 to 16:12 so that a video formatted according to the standard aspect ratio of 16:9 becomes letterboxed leaving a black band across the top and bottom of the screen. The addition of a 16:1.5 aspect ratio adtrack above or below the primary video image, which does not overly the primary video image, forms a composite video with aspect ratio 16:10.5. This size is ideally sized to fit the screens of many mobile devices with little or no need for the video player to letterbox or pillar the video.

Aspects of the invention can be of benefit to content owners (proprietors of the primary videos) because technology has made it relatively easy to capture a streaming video and users often capture and collect libraries of music and other videos that they can use themselves or share with friends. Content owners often see this as a violation of their rights. By integrating the advertising into a title and serving them together as a single video stream, the appeal of the video to collectors decreases significantly. And when videos are nevertheless collected, advertisers will have their messages distributed more widely at no additional cost.

Aspects of the invention can be of benefit to advertisers because of the duration of user exposure to a message, the flexibility in the design and wording of the message, and the ability to provide multiple messages during the course of a single video. One of the problems with banner ads on static web pages is that viewers often do not spend sufficient time on a web page for the message to register. By converting a graphic banner or a number of graphic banners to a video track and embedding the track with the video title, advertisers can be assured that not only will their message be seen, but it will be seen for a predetermined duration. The duration of the message on screen can be set from a few seconds to the length of the primary video, and/or it can be repeated at a regular interval in a cycle that includes other graphic banners.

For example, a particular composite video asset may include in the advertising region of the pictures two messages (i.e. two different images) from each of three advertisers, with each message appearing on screen for 10 seconds. This yields an adtrack of one minute duration which can be looped and repeated for the entirety of the primary video. Other options might be two advertisers with two messages each, 15 seconds run time for each message; or four advertisers with two messages each, 7.5 seconds run time for each message; or three advertisers with three messages each, 10 seconds run time for each message (for a total cycle of 90 seconds in each cycle), and so on.

The above summary of the invention is provided in order to provide a basic understanding of some aspects of the invention. This summary is not intended to identify key or critical elements of the invention or to delineate the scope of the invention. Its sole purpose is to present some concepts of the invention in a simplified form as a prelude to the more detailed description that is presented later. Particular aspects of the invention are described in the claims, specification and drawings.

### BRIEF DESCRIPTION OF THE DRAWINGS

The invention will be described with respect to specific embodiments thereof, and reference will be made to the drawings, in which:

FIGS. 1 and 11 are system diagrams illustrating components of video streaming systems incorporating aspects of the invention in different embodiments.

FIG. 2 is a simplified block diagram of a computer system that can be used to implement each or all of the facilities of FIG. 1.

FIGS. 3A, 3B and 3C (collectively FIG. 3) and 4A and 4B (collectively FIG. 4) each illustrate a picture or a portion of a picture from a video.

FIGS. 5 and 7 are flow charts for describing a first method for preparing composite video assets.

FIGS. 6 and 8 illustrate sample database formats that can be used in the adtrack database and the composite assets database of FIG. 1, respectively.

FIGS. 9 and 10 are flow charts for describing a second method for preparing composite video assets.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not intended to be limited to the embodiments shown, but is to be accorded the widest scope consistent with the principles and features disclosed herein.

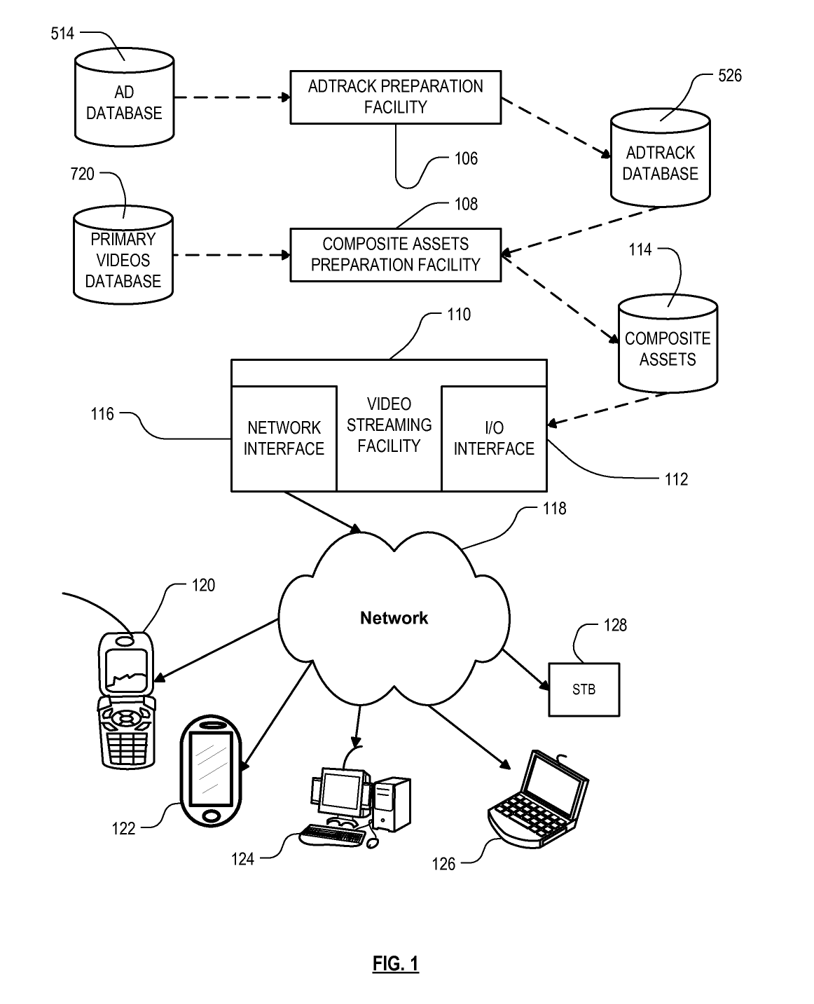

FIG. 1 is a system diagram illustrating components of a video streaming system incorporating aspects of the invention in one embodiment. It comprises a video server having a streaming facility 110, which includes an I/O interface 112 for retrieving composite video assets from a database 114. The composite video assets in the database 114 are stored there in a non-transitory manner. The streaming server facility 110 also has a network interface 116 for streaming the video across a network 118 toward one or more receiving devices. The system further includes an adtrack preparation facility 106, a composite assets preparation facility 108, an ad database 514, an adtrack database 526 and a primary videos database or library 720, all of which are discussed in more detail hereinafter.

In various embodiments each of the facilities 106, 108 and 110 may be any type of computer system, dedicated device, or distributed system, even spread out over multiple locations and interconnected by a network such as 118. The three facilities 106, 108 and 110 may also be combined into two or even one physical location, or their functions may be divided up differently than as shown in FIG. 1. The composite assets database 114 is shown connected to the video streaming facility 110 via an I/O interface 112 of the video streaming facility 110, but it will be understood that in various embodiments the composite assets database 114 can be divided up and stored, redundantly or not, at multiple locations, each of which can be coupled to one part or another of the video streaming facility 116. Similarly, the ad database 514 is shown in communication with the adtrack preparation facility 106, but it will be understood that in various embodiments the ad database 514 can be divided up and stored, redundantly or not, at multiple locations, each of which can be coupled to one part or another of the adtrack preparation facility 106. Similarly again, the adtrack database 526 is shown in communication with the adtrack preparation facility 106 and the composite assets preparation facility 108, but it will be understood that in various embodiments the adtrack database 526 can be divided up and stored, redundantly or not, at multiple locations, each of which can be coupled to one part or another of the adtrack preparation facility 106 and the composite assets preparation facility 108. As used herein, the term “database” does not necessarily imply any unity of structure. For example, two or more separate databases, when considered together, still constitute a “database” as that term is used herein.

The network 118 is a combination of circuitry through which a connection for transfer of data can be established between machines or devices. As used herein, a network can include local area networks (LANs), wide area networks (WANs), the Internet, and any other medium through which video can be streamed. It includes both wireline and wireless (e.g. satellite, cellular or WiFi) networks, which may be data-centric or voice-centric, or may be designed for cable, satellite or IPTV video delivery.

The receiving devices include for example mobile phones 120, tablet PC's 122, desktop computers 124, laptop computers 126, set-top-boxes (STBs) 128 as well as (not shown) smart phones and PDAs. While the overall system may deliver composite video assets according to the invention to any of such devices and others, it will be appreciated that benefits of the invention will be more apparent when the receiving device is not capable of displaying more than a single video stream at a time, nor displaying overlays, nor handling other methods for display of an advertisement adjacent or close to streaming video images.

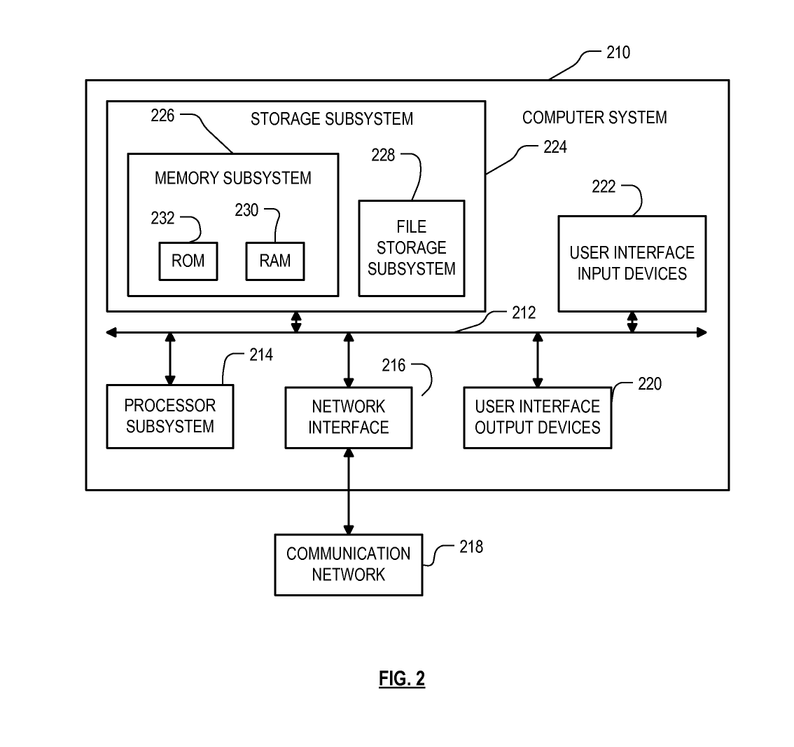

FIG. 2 is a simplified block diagram of a computer system 210 that can be used to implement each or all of the facilities 106, 108 and 110 (FIG. 1). In an embodiment in which a particular one of such facilities includes more than one computer system, some or all of them can be implemented according to the diagram of FIG. 2. While the flow charts set forth herein indicate individual process steps, it will be appreciated that each step actually comprises a hardware module or a module programmed in software and executed by a computer system such as 210 which causes the computer system to perform the step indicated.

Computer system 210 typically includes a processor subsystem 214 which communicates with a number of peripheral devices via bus subsystem 212. These peripheral devices may include a storage subsystem 224, comprising a memory subsystem 226 and a file storage subsystem 228, user interface input devices 222, user interface output devices 220, and a network interface subsystem 216. The input and output devices allow user interaction with computer system 210. Network interface subsystem 216 corresponds to network interface 116 (FIG. 1) and provides an interface to outside networks, including an interface to communication network 218, which corresponds to network 118 (FIG. 1). Communication network 218 may comprise many interconnected computer systems and communication links. These communication links may be wireline links, optical links, wireless links, or any other mechanisms for communication of information. While in one embodiment, communication network 218 is the Internet, in other embodiments communication network 218 may be any suitable computer network.

The physical hardware component of network interfaces are sometimes referred to as network interface cards (NICs), although they need not be in the form of cards: for instance they could be in the form of integrated circuits (ICs) and connectors fitted directly onto a motherboard, or in the form of macrocells fabricated on a single integrated circuit chip with other components of the computer system.

User interface input devices 222 may include a keyboard, pointing devices such as a mouse, trackball, touchpad, or graphics tablet, a scanner, a touch screen incorporated into the display, audio input devices such as voice recognition systems, microphones, and other types of input devices. In general, use of the term “input device” is intended to include all possible types of devices and ways to input information into computer system 210 or onto computer network 218.

User interface output devices 220 may include a display subsystem, a printer, a fax machine, or non-visual displays such as audio output devices. The display subsystem may include a cathode ray tube (CRT), a flat-panel device such as a liquid crystal display (LCD), a projection device, or some other mechanism for creating a visible image. The display subsystem may also provide non-visual display such as via audio output devices. In general, use of the term “output device” is intended to include all possible types of devices and ways to output information from computer system 210 to the user or to another machine or computer system.

Storage subsystem 224 stores the basic programming and data constructs that provide the functionality of certain embodiments of the present invention. For example, the various modules implementing the functionality of certain embodiments of the invention may be stored in storage subsystem 224. These software modules are generally executed by processor subsystem 214. Storage subsystem 224 also can include part or all of the one or more databases depicted in FIG. 1.

Memory subsystem 226 typically includes a number of memories including a main random access memory (RAM) 230 for storage of instructions and data during program execution and a read only memory (ROM) 232 in which fixed instructions are stored. File storage subsystem 228 provides persistent storage for program and data files, and may include a hard disk drive, a floppy disk drive along with associated removable media, a CD ROM drive, an optical drive, or removable media cartridges. The databases and modules implementing the functionality of certain embodiments of the invention may have been provided on a computer readable medium such as one or more CD-ROMs, and may be stored by file storage subsystem 228. The host memory 226 contains, among other things, computer instructions which, when executed by the processor subsystem 214, cause the computer system to operate or perform functions as described herein. As used herein, processes and software that are said to run in or on “the host” or “the computer”, execute on the processor subsystem 214 in response to computer instructions and data in the host memory subsystem 226 including any other local or remote storage for such instructions and data.

Bus subsystem 212 provides a mechanism for letting the various components and subsystems of computer system 210 communicate with each other as intended. Although bus subsystem 212 is shown schematically as a single bus, alternative embodiments of the bus subsystem may use multiple busses.

Computer system 210 itself can be of varying types including a personal computer, a portable computer, a workstation, a computer terminal, a network computer, a television, a mainframe, a server farm, or any other data processing system or user device. Due to the ever-changing nature of computers and networks, the description of computer system 210 depicted in FIG. 2 is intended only as a specific example for purposes of illustrating the preferred embodiments of the present invention. Many other configurations of computer system 210 are possible having more or less components than the computer system depicted in FIG. 2.

A video, as the term is used herein, refers to a sequence of pictures which are displayed in sequence in such a way that changes in the position of objects in successive ones of the images are perceived by a viewer as motion. Each of the individual pictures may be stored in spatially compressed or uncompressed form, and groups of the pictures may be stored in temporally uncompressed or compressed form. Numerous compression standards are known for storing videos, one commonly used example of which is known as H.264/MPEG-4 Advanced Video Coding standard (H.264/AVC). H.264 is an industry standard for video compression jointly developed by the ITU-T Video Coding Experts Group (VCEG) and the ISO/IEC Moving Picture Experts Group (MPEG), and is described in, for example, ITU-T, SERIES H: AUDIOVISUAL AND MULTIMEDIA SYSTEMS, Infrastructure of audiovisual services—Coding of moving video, Advanced video coding for generic audiovisual services (June 2011), incorporated herein by reference. As used herein, any compression method that satisfies the above-incorporated definition of the H.264 standard is considered to constitute “an H.264 compression method”, whether or not it also satisfies subsequent revisions of H.264. Earlier versions of the standard are known as MPEG-1 and MPEG-2, which are defined in ISO/IEC 11172: ‘Coding of moving pictures and associated audio for digital storage media at up to about 1.5 Mbit/s’ and ISO/IEC 13818: ‘Generic coding of moving pictures and associated audio (MPEG-2)’, respectively, both incorporated by reference herein. MPEG-2 is also described in Tudor, P. N., “MPEG-2 Video Compression,” Tutorial, Electronics & Communication Engineering Journal, December 1995, incorporated herein by reference. As used herein, any compression method that satisfies any version of the MPEG video compression standard is considered to constitute “an MPEG compression method”, whether or not it also satisfies subsequent revisions of the standard. Note that compression of video does not by itself require re-sizing any picture within the video. Also, “movie” is used herein to mean the same as “video”.

As illustrated in Tudor, the MPEG standards encode videos in such a way as to identify each “picture” in a separately identifiable container, each with its own separate header information. As used herein, a “picture” is the image to be displayed at a particular point in the temporal sequence, even if as compressed, information from more than one picture is required to reconstruct it. Thus a video “identifies” its constituent pictures. As used herein, the “identification” of an item of information does not necessarily require the direct specification of that item of information. Information can be “identified” by simply referring to the actual information through one or more layers of indirection, or by identifying one or more items of different information (such as previous and subsequent images) which are together sufficient to determine the actual item of information. In addition, the term “indicate” is used herein to mean the same as “identify”.

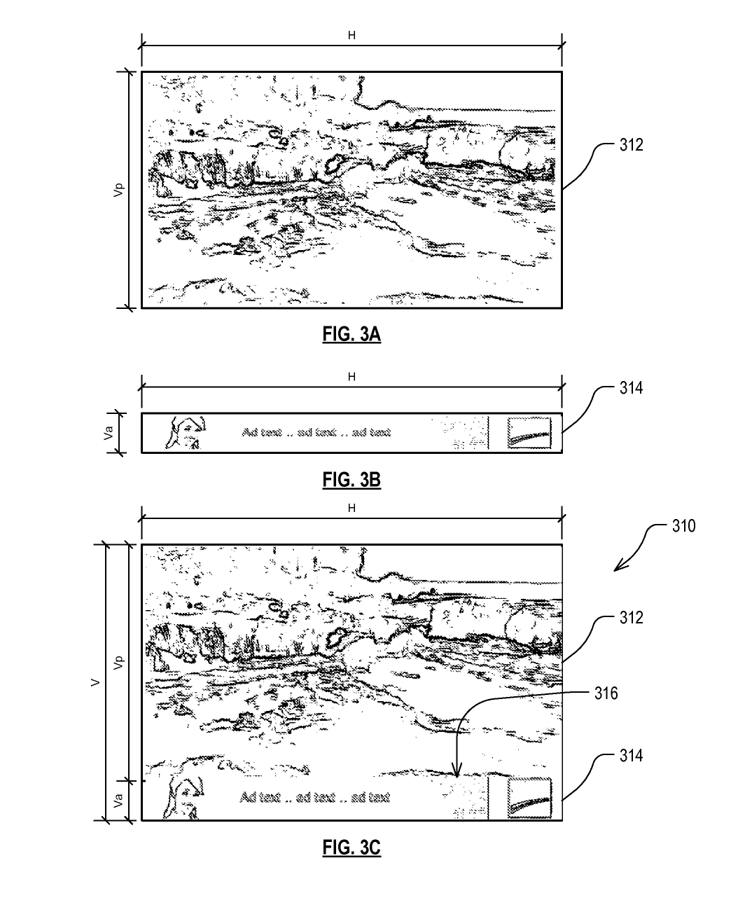

FIG. 3C illustrates a sample picture 310 from a video asset in the composite video assets database 114. It is rectangular, having an aspect ratio of H:V. It has two regions 312 and 314, which are themselves rectangular. Region 312 has an aspect ratio H:Vp, whereas region region 314 has an aspect ratio H:Va. Both Vp and Va are smaller than V, and V=Vp+Va. As shown in FIG. 3C there is no line of demarcation between the two regions, though in some embodiments a visible line can be included. Since both regions 312 and 314 are part of the overall picture 310, the compressed form of the picture includes both regions together in a single container and makes no distinction between them. Compression equipment does not need to know that the picture 310 is composed of two separate regions, since it simply compresses the single picture 310 as a unitary object using whatever algorithms it would otherwise use to compress a picture. Playback equipment (such as the devices 120, 122, 124, 126 and 128) also does not need to know that the picture 310 is composed of two separate regions, since it simply reconstructs the single picture 310 using whatever algorithms it would otherwise use to reconstruct a picture. Where the compression method satisfies a standard which defines a “picture”, as do MPEG and H.264, the images in the two regions 312 and 314 are composited together in each picture of the composite video asset in a manner that satisfies a definition in the compression standard of a single “picture”. Importantly, spatial compositing of the images in the two regions takes place prior to streaming transmission to the user device. This is in contrast to prior arrangements in which separate videos are streamed concurrently to the user, and the user device composites them together on the display. As used herein, “streaming” transmission of media refers to transmission of media that is received by the receiving device and presented to a user while being transmitted by a streaming provider. The receiving device can start presenting the media to the user before the entire file has been transmitted by the provider.

In the video asset that contains picture 310, successive pictures carry a movie within the rectangular region 312, and successive pictures carry a number of temporally-arranged advertising images in the rectangular region 314. The content of region 312 is illustrated in FIG. 3A, and the content of region 314 is illustrated in FIG. 3B. The region 314 is adjacent to the region 312 along a common edge 316, and has the same length (H) along common edge 316. Preferably the height of the region 314 is much smaller than that of the region 312, region 314 being at least five times, and preferably six times, the height of region 314. Region 312 may for example have a standard aspect ratio, such as 16:9, and the region 314 has aspect ratio 16:1.5 (the height of region 312 being six times the height of region 314). Alternatively if region 312 has the aspect ratio 16:9, the region 314 may have aspect ratio 16:1.8 (the height of region 312 being five times the height of region 314). As another alternative, region 312 may have the standard aspect ratio 4:3, and region 314 may have aspect ratio 4:0.5 (the height of region 312 being six times the height of region 314). In still another alternative if region 312 has the aspect ratio 4:3, the region 314 may have aspect ratio 4:0.6 (the height of region 312 being five times the height of region 314).

In the embodiment of FIG. 3C the region 314 is disposed below the region 312, but in another embodiment region 314 can be disposed above region 312. In still other embodiments, the region containing advertising images can be left- or right-adjacent to region 312 rather than above or below.

The video asset was formed, as described in more detail hereinafter, by spatially compositing an “adtrack” adjacent to the bottom edge of a primary video which remains intact in region 312. The adtrack preferably does not overlap, intrude on or distort the primary video, so as not to annoy the viewer or disrupt the viewing experience. In an embodiment in which the primary video was designed to have a standard aspect ratio, it is significant and non-intuitive that the resulting composite video asset has an aspect ratio that is non-standard. In other attempts to display advertisements with video an effort is typically made to retain the standard aspect ratio for which the starting video was originally designed. This is usually accomplished by overlaying the advertising images in some way over the starting video. In the embodiment of FIG. 3C, on the other hand, non-intrusion of the advertising images onto the primary video results in a composite video having a non-standard aspect ratio. A primary video having a standard “HD” aspect ratio of 16:9 yields a composite video having a non-standard aspect ratio of 16:10.5. As mentioned, this new aspect ratio often fits the screens of mobile devices better than the starting video, reducing letterboxing and pillaring of the images.

The adtrack is made up of a series of static advertising images which are composited temporally for the duration of the primary video. In one embodiment the advertising images are banner ads, provided in .jpg format. The temporally-arranged advertising images need not be temporally-adjacent, though preferably they are. Nor do they need to extend temporally from the very beginning to the very end of the primary video, though preferably they do. They also can overlap with each other somewhat temporally, as when one advertisement fades into the next. It is necessary, however, that at least some pictures show only one of the advertising images and at least some subsequent pictures show only the next advertising image.

In an embodiment in which the ad images desirably remain on-screen for long enough to register with the viewer, in one embodiment each picture sequence carrying exclusively one advertising image is displayed in the video asset for at least five seconds before being replaced by the next ad image. A typical duration might be for example 10 seconds, which appears to strike a beneficial balance between the duration needed to register with the viewer, and a frequency of turnover allowing sufficient numbers of advertisements sharing the cost. In an embodiment, an adtrack in a given video asset comprises a sequence of n different advertising images repeated m times, where n and m are integers greater than one. For example, it may be made up of three different advertising images repeated in sequence, for as many cycles as are needed to extend the entire duration of the primary video. In one embodiment, a composite video asset has a duration between 10 and 20 minutes inclusive, and n is between 3 and 5, inclusive. Typically the number of different images portrayed over time in the primary video region of each picture far exceeds the number of different images portrayed in the adtrack region over the same time period.

In another embodiment, the primary video divides naturally into segments, such as is often the case with news reports and talk shows. In that situation the adtrack in region 314 can advantageously display one ad for the entire duration of each segment, and transitions to the next ad image at the beginning of the next segment.

It is preferable that the advertising images not include any motion, so as to avoid annoying the viewer with distractions. However, the advertising images can include some motion in some embodiments. If they do, there is a transition from one advertisement to the subsequent advertisement which is clearly perceptible to a viewer, by reason of different imagery, color scheme, style, advertising message, or the like.

### Preparation of Composite Videos

In one embodiment, composite video assets in the database 114 are prepared and stored in the database 114 prior to being streamed. They may be prepared in advance, or preparation may be triggered in response to a user request for a particular primary video. In either case the composite asset is written, partially or completely, into the database 114 before being streamed. If preparation is triggered by a user request, the composite video may be cached in the database 114 so it need not necessarily be prepared again in response to the next user request for the same primary video.

Whether or not composite video preparation is triggered by user request, one embodiment prepares adtracks in advance, without such a trigger. An adtrack preparation facility 106 (FIG. 1) is in communication with both an ad database 514 containing source advertising images, and an adtrack database 526, containing finished adtracks ready for spatial compositing. These two databases are accessible to the adtrack preparation facility 106 via either its file storage subsystem or its network interface (228 and 216, respectively, in the illustration of FIG. 2).

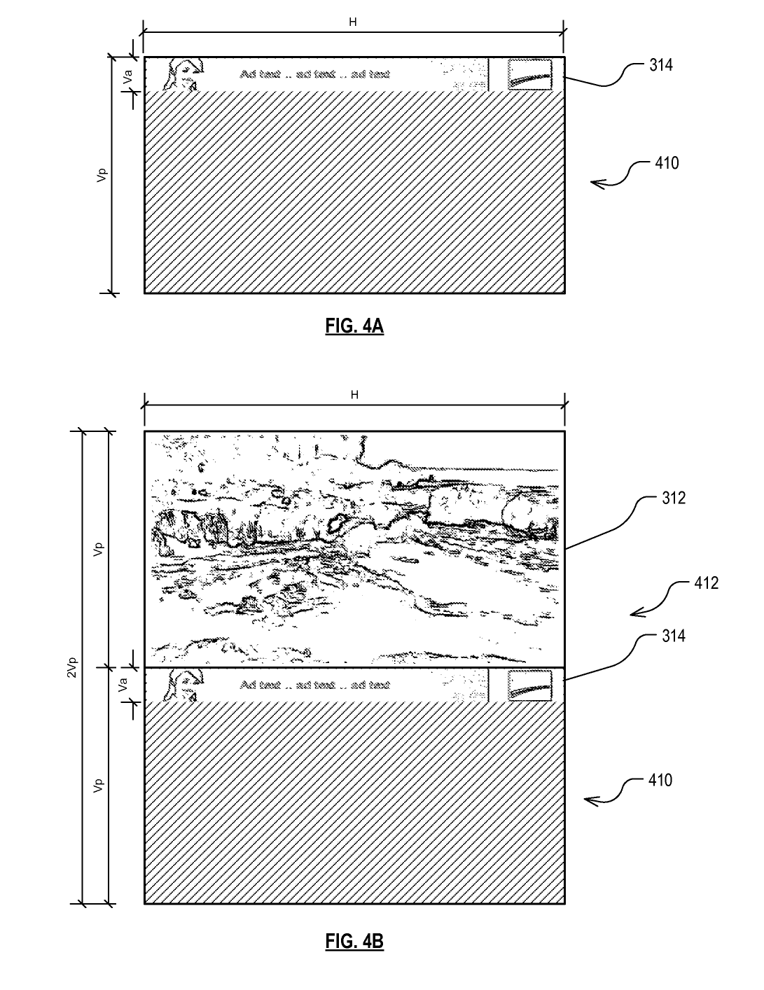

FIG. 5 is a flow chart of steps performed by software modules in the adtrack preparation facility 106. As with all flowcharts herein, it will be appreciated that many of the steps can be combined, performed in parallel or performed in a different sequence without affecting the functions achieved. In some cases a re-arrangement of steps will achieve the same results only if certain other changes are made as well, and in other cases a re-arrangement of steps will achieve the same results only if certain conditions are satisfied.

Referring to FIG. 5, in step 510, the facility 106 determines the number of ads to include in a current adtrack being prepared. This can be a fixed number (e.g. 3) in some embodiments, or in other embodiments it could depend on the duration of a primary video with which the adtrack will be composited (if known). That is, longer primary videos may permit more ads in the adtrack.

In step 512, the facility 106 selects an ad from the ad database 514. Typically an adtrack is directed toward a known target audience demographic, and step 512 chooses an ad in database 514 which is targeted toward that demographic.

Preferably, advertisers are given standard dimensions, either by pixel height and width or at least by aspect ratio, in which their ad images are to be provided. This should be the size (or aspect ratio) needed for spatial compositing as illustrated in FIG. 3C. If ad images in the ad database 514 are not of the required size for some reason, then in step 516 the selected ad is resized and either cropped, letterboxed or pillared as necessary to yield the required pixel width and height.

In step 518 the correctly sized ad image is converted to a video segment a predetermined duration, e.g. 10 seconds. Off-the-shelf software packages can be used to perform this conversion. An example such software package is Final Cut Pro(R), available from Apple Computer, Cupertino, Calif.

In step 520, the adtrack preparation facility 106 decides whether to include another ad in the adtrack, and if so, it returns to step 512 to select the next ad.

If no more ads are to be included in the current adtrack, then in step 522 the facility 106 temporally composites the ad segments into a single video. Preferably it composites the ads temporally adjacent to each other, then repeats the total sequence as many times as necessary to prepare a video that is at least as long as the longest primary video to which the adtrack might be applied. For example, if the primary videos are stored in a library, and it is known that the longest primary video in the library is 15 minutes in duration, then the sequence of ads may be repeated in the adtrack a sufficient number of times so that the final adtrack has a duration of 20 minutes.

In step 524 the newly prepared adtrack is written to adtrack database 526. In step 528 the adtrack preparation facility 106 decides whether to prepare another adtrack, and if so, it returns to step 510 to determine the number of ads to include in it.

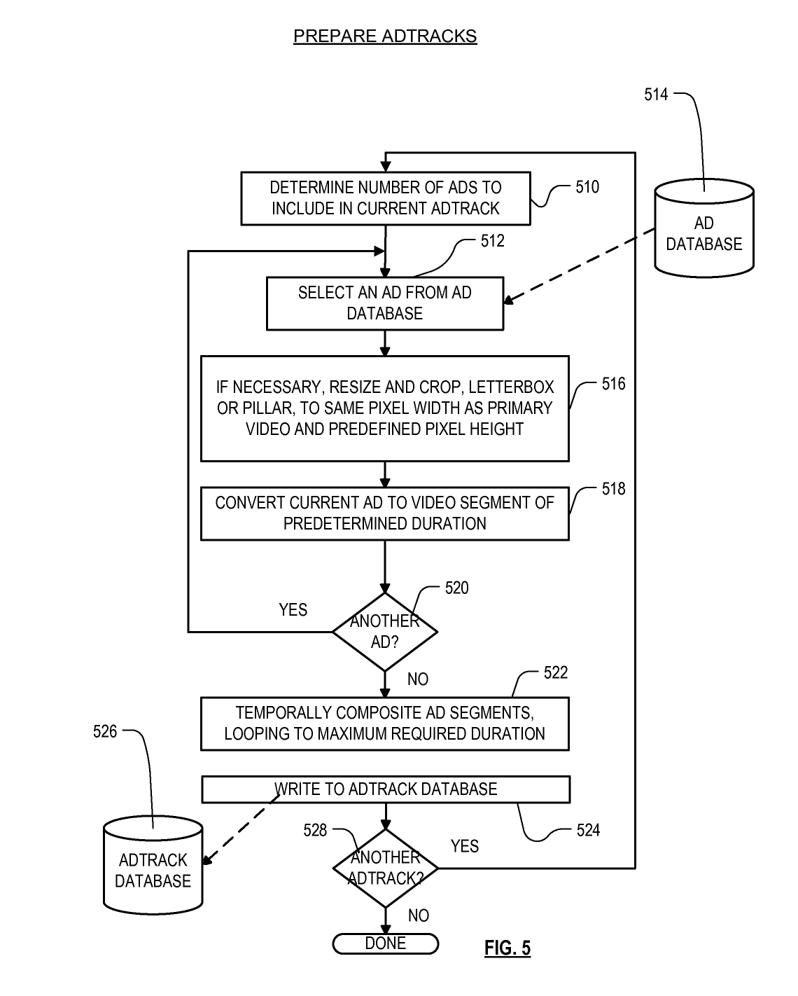

One of the functions of ad servers is to keep track of the number of times each ad has been viewed. FIG. 6 illustrates an example format for the adtrack database 526 which facilitates that function. In addition to files containing the adtracks themselves, the database includes a table having an entry (row) for each adtrack. In each entry, fields (columns) are provided for an adtrack identifier, a pointer to the file containing the adtrack, an indication of the number of views that are required for this adtrack, and an indication of the current view count so far. The number of views required is typically the number ordered or paid for by the advertiser, and may for example be 0.5 million or 1 million. The ads in the adtrack are selected (in step 512) such that all have the same number of required views. The current view count field is incremented each time a composite video that contains the adtrack is streamed, the increment being the number of repetitions of the adtrack in that video. When the current view count equals or exceeds the number of views required, then the particular adtrack is expired. Note that the adtrack database can also include other fields relevant to each adtrack, such as an identification of the particular adtrack's target demographic.

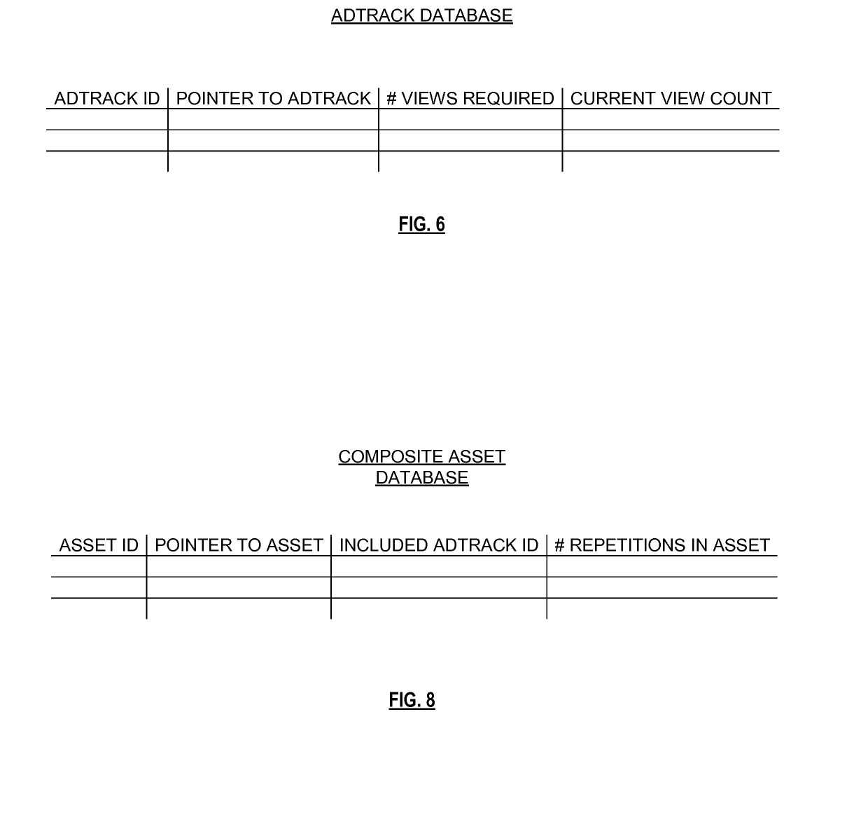

FIG. 7 is a flow chart of steps performed by the composite assets preparation facility 108 in combination with the video streaming facility 110, in response to user selection of a particular primary video from the library, in an embodiment in which such selection triggers creation of the corresponding composite video asset. In step 710, the user selects a desired primary video from the library. As mentioned, this video typically is already of standard aspect ratio, such as 16:9. In step 712, it is determined whether a composited video asset already exists in the composite assets database 114, and the included adtrack has not expired. It may exist there because it was created in response to a previous request and cached there, or it may exist because a separate process created it prior to any such user request. If the asset exists and its adtrack has not expired, then in step 714 the video streaming facility 110 transmits the composite asset toward the user's device as previously described.

If either no corresponding composite asset is present in the database 114, or one is present but its adtrack has expired, then in step 716 an appropriate adtrack is selected from the adtrack database 526. In an embodiment, the adtrack is selected based on a demographic appropriate for the primary video selected by the user.

In step 718, the selected primary video is retrieved from the primary videos database 720, and spatially composited with the selected adtrack. As illustrated in FIGS. 3A-3C, the spatial compositing positions the adtrack immediately below (in this embodiment) and adjacent to the primary video. The adtrack, which should be longer in duration than the primary video, is truncated in this process to the duration of the primary video. The spatial compositing does not change the aspect ratio of the primary video, nor does it intrude spatially into the primary video. The adtrack is merely stitched adjacent to the primary video either above, below, or to the left or right of the primary video. As mentioned, this creates a composite video having a non-standard aspect ratio, such as 16:10.5 or 16:10.8.

In step 722, the composited video asset is written to the composite assets database 114 and cached there, and in step 714 it is transmitted to the user.

As mentioned, the system may also include a background process that creates composite video assets from the videos in the primary videos library 720, even before they are requested by a user. Such a facility includes a step of selecting a primary video to composite, followed by steps 712, 716, 718 and 722 of FIG. 7. The facility then loops back to select the next primary video to composite. In such a system, many videos can be pre-composited and stored in the composite assets database 114 so they are already ready when requested.

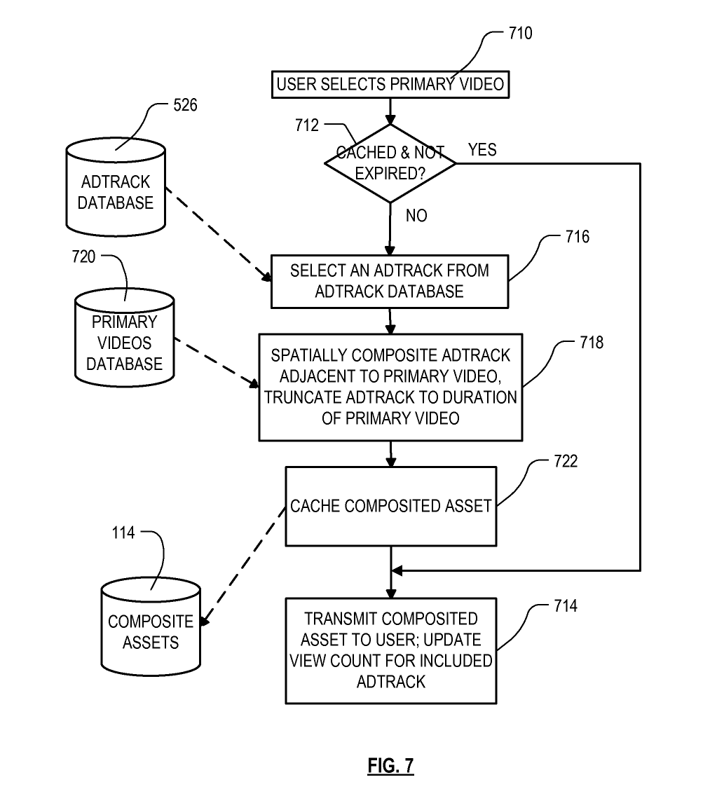

FIG. 8 illustrates an example format for the composite video assets database 114. In addition to files containing the composite assets themselves, the database includes a table having an entry (row) for each composite asset. In each entry, fields (columns) are provided for an asset identifier, a pointer to the file containing the asset, an identifier of the adtrack included in the asset, and an indication of the number of times each ad is repeated in the asset. When an asset is streamed, the amount by which the current view count field in the adtrack database of FIG. 6 is incremented is given by this last field in the current row of the composite asset database of FIG. 8. The composite asset database can also include other fields, and other implementations for the databases of FIGS. 6 and 8 will be apparent to the reader.

### Alternate Method of Preparing Composite Videos

It will be appreciated that the flow charts of FIGS. 5 and 7 illustrate only one method to prepare the composite video assets to be streamed. In another embodiment, composite video asset preparation facility 108 loops through the primary video picture-by-picture, and on each picture, it spatially composites the picture with a selected below-adjacent ad image. It then re-packages the resulting sequence of spatially composited pictures and compresses it to form the desired composite video asset. The resulting asset has all the same features as described above with respect to FIG. 3C.

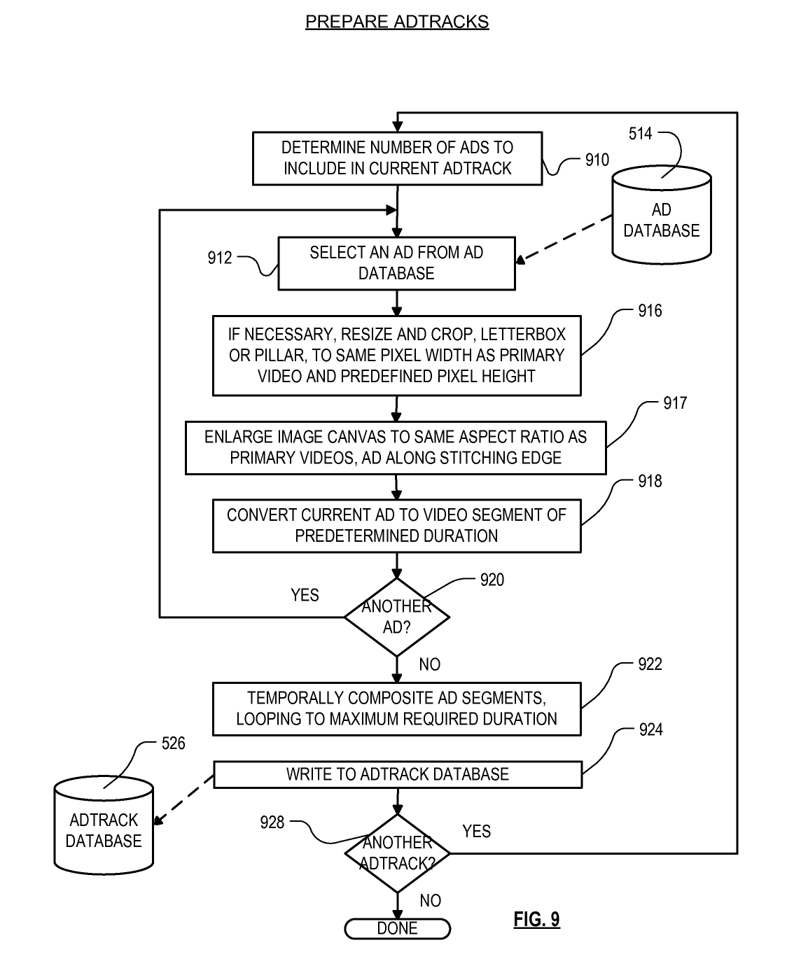

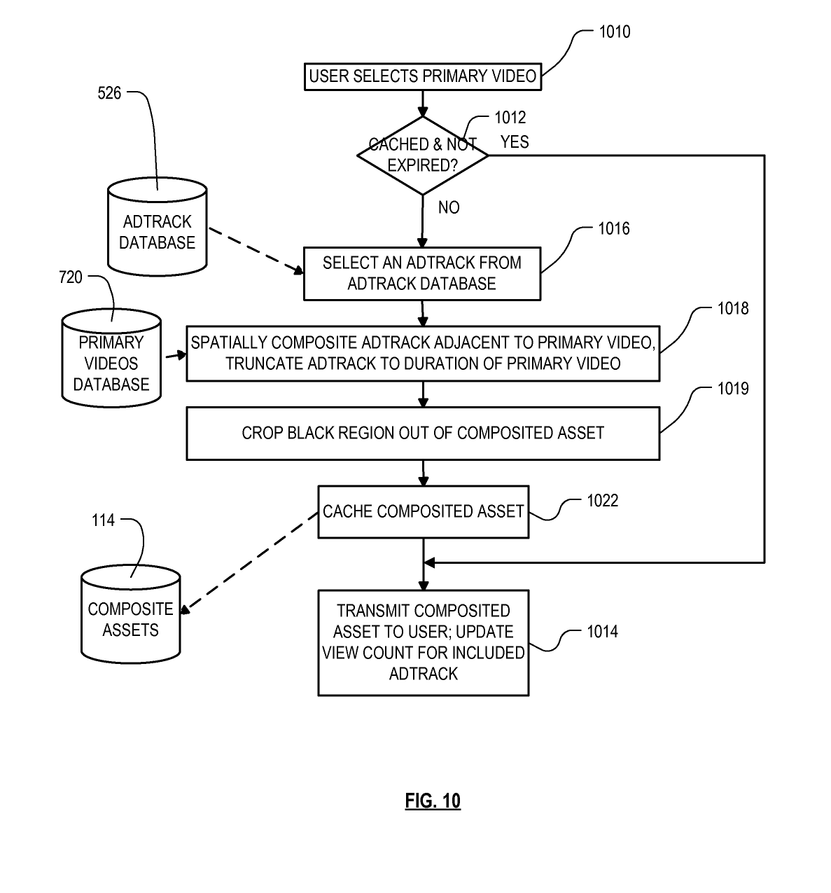

Yet another method to prepare composite video assets is illustrated in the flow charts of FIGS. 9 and 10. FIG. 10 illustrates a slightly different way of spatially compositing primary video pictures with adtrack pictures, and FIG. 9 sets forth a method for preparing the type of adtracks used in the method of FIG. 10. In the following description, steps that are the same as corresponding steps in FIGS. 5 and 7 will be explained here only briefly, and reference should be made to the corresponding steps in FIGS. 5 and 7 for additional detail.

Referring to FIG. 9, in step 910, the adtrack preparation facility 106 determines the number of ads to include in a current adtrack being prepared. In step 912, the facility 106 selects an ad from the ad database 514. In step 916, if necessary, the selected ad is resized and either cropped, letterboxed or pillared as necessary to yield an image of the proper size (or aspect ratio) as needed for spatial compositing as illustrated in FIG. 3C.

In step 917, the image canvas for the ad image is enlarged so that it has the same aspect ratio as that of the primary video with which it will be spatially composited. This step, which prepares the image for use with the spatial compositing function of certain off-the-shelf software as described hereinafter, is illustrated in FIG. 4A. It can be seen that the canvas has been enlarged below the ad image 314 such that it is adjacent to the top edge of the canvas. The new image 410 has a width H and a height Vp, both of which are the same as that of the primary video with which it will be composited. The portion of the picture below the ad image 314 is black, but it can have any content at all since it will be cropped away in a later step.

In step 918 the ad image on the enlarged canvas is converted to a video segment a predetermined duration, and in step 920, the adtrack preparation facility decides whether to include another ad in the adtrack. If so, then it returns to step 912 to select the next ad. If no more ads are to be included in the current adtrack, then in step 922 the facility 106 temporally composites the ad segments into a single video, looping the sequence as necessary to yield an adtrack video that is at least as long as the longest primary video to which the adtrack might be applied. In step 924 the newly prepared adtrack is written to adtrack database 526. In step 928 the adtrack preparation facility 106 decides whether to prepare another adtrack, and if so, it returns to step 910 to determine the number of ads to include in it.

Referring now to FIG. 10, in step 1010, the user selects a desired primary video from the library. In step 1012, it is determined whether a composited video asset already exists in the composite assets database 114, and the included adtrack has not expired. If the asset exists and its adtrack has not expired, then in step 1014 the video streaming facility 110 transmits the composite asset toward the user's device as previously described. If either no corresponding composite asset is present in the database 114, or one is present but its adtrack has expired, then in step 1016 the composite assets preparation facility 108 selects an appropriate adtrack from the adtrack database 526.

In step 1018, the composite assets preparation facility 108 retrieves the selected primary video from the primary videos database 720, and spatially composites it with the selected adtrack. The adtrack is truncated during the compositing process to the duration of the primary video. FIG. 4B is an illustration of the spatial compositing involved in this step. As can be seen, the spatial compositing positions the adtrack immediately below (in this embodiment) and adjacent to the primary video. Since the adtrack video 410 has the same height Vp as the primary video 312, the resulting combined video has pictures which are of height 2Vp. The width remains the same, H. Step 1018 can be performed by off-the-shelf software packages, such as MediaCoder 2011, available at www.mediacoderhq.com. In step 1019 the composited video is cropped to remove the extraneous portion below the adtrack 314, thereby leaving a video of aspect ratio H:V, where V=(Vp+Va), as shown in FIG. 3C. Step 1019 can be performed by off-the-shelf software packages, such as Handbrake, available at handbrake.fr.

In step 1022, the composited video asset is written to the composite assets database 114 and cached there, and in step 1014 it is transmitted to the user.

Note that if the adtrack is to be stacked above the primary video 312 as opposed to below it, then in step 917 the ad images would be disposed at the bottom edge of canvas 410 instead of at the top edge, and in step 1018 it would be composited above the primary video images 312 instead of below it. The cropping step 1019 would crop the extraneous material at the top of each picture rather than at the bottom. Similar adaptations will be apparent if the adtrack is to be disposed left- or right-adjacent the primary video images.

### Live Streaming Embodiment

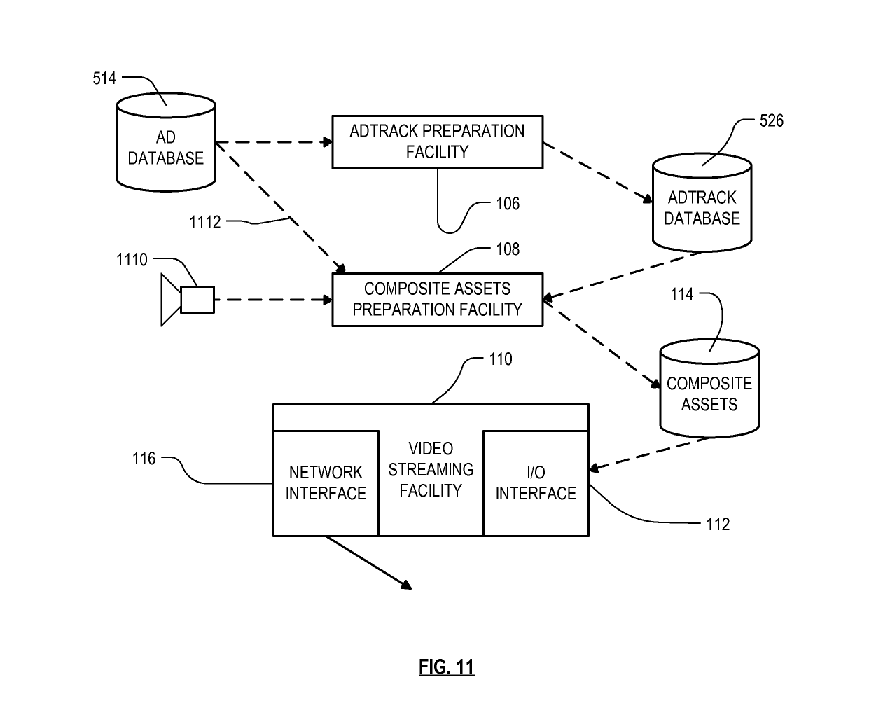

The concepts set forth above for adding advertising to fixed starting videos can also be applied for streaming live video being taken at an event, such as a music festival, concert, sporting event and so on. This can be implemented for example using the system of FIG. 11, which is a system diagram much like that of FIG. 1, except that the primary videos database 720 has been replaced by a live video source, such as camera 1110. Many of the principles described above with respect to fixed starting videos apply equally to sources of live video. The following process can take place with such a system.

First, the event is captured with appropriate recording equipment. FIG. 11 shows only one camera 1110, but that should be considered as symbolic of all kinds of recording equipment, including multiple cameras and mixing desks.

The live video is streamed to the composite assets preparation facility 108, which in real time spatially composites each picture, frame-by-frame, with the adtrack. In one embodiment prepared adtracks can be used here from the adtrack database 526, as set forth above. Since compositing is performed picture by picture in this embodiment, though, reconstructing the individual ad images from an adtrack video is a roundabout method. In another embodiment, it is simpler to retrieve the appropriate ad image directly from the ad database 514, bypassing the creation of adtrack videos altogether (see arrow 1112).

The sequence of spatially composited pictures is then compressed into a video, for example using H.264, and passed to the video streaming facility 110 for streaming toward the user device. In some embodiments, the composite assets preparation facility 108 and the video streaming facility 110 can be implemented as separate modules in a single computer system, or even as a single combined module in a single computer system.

It is noteworthy that the process of spatially compositing pictures and compressing them, and even staging them for streaming transmission, all involve storing the pictures for at least a short time in a database. If the video is transmitted at 30 frames per second, for example, each picture is stored in the database for at least 1/30 seconds, and probably much longer. In fact, since the various processing stages of these steps are pipelined, the time lag experienced by each picture from the time it leaves camera 1110 to the time it is transmitted by video streaming facility 110 can be as long as one minute or more, which implies that at any given time, a picture sequence having a duration on the order of tens of seconds or more is stored in the system. As used herein, that picture sequence (as well as each shorter segment of that picture sequence) is considered to constitute a “video”. It will be appreciated that these videos are stored non-transiently in the system.

Many options are available for choosing the ad images to composite with the live video. If the event runs for an hour, for example, as many advertisers and messages as seems desirable can be temporally composited in the adtrack region of the pictures in the resulting feed. For example each ad might be displayed for one minute, since a higher frequency of ad turnover may be distracting to the viewer. If a prepared adtrack database is used, then any number of pre-produced adtracks can be used. In one embodiment, each adtrack is repeated for a predetermined duration of the event, for example one hour, and then the next pre-produced adtrack is used. Alternatively, a pool of 3-4 adtracks (each cycling through several ad images) can themselves be cycled at predetermined intervals. Numerous other options will be apparent to the reader.

The applicant hereby discloses in isolation each individual feature described herein and any combination of two or more such features, to the extent that such features or combinations are capable of being carried out based on the present specification as a whole in light of the common general knowledge of a person skilled in the art, irrespective of whether such features or combinations of features solve any problems disclosed herein, and without limitation to the scope of the claims. The applicant indicates that aspects of the present invention may consist of any such feature or combination of features.

The foregoing description of preferred embodiments of the present invention has been provided for the purposes of illustration and description. It is not intended to be exhaustive or to limit the invention to the precise forms disclosed. Obviously, many modifications and variations will be apparent to practitioners skilled in this art. In particular, and without limitation, any and all variations described, suggested or incorporated by reference in the Background section of this patent application are specifically incorporated by reference into the description herein of embodiments of the invention. The embodiments described herein were chosen and described in order to best explain the principles of the invention and its practical application, thereby enabling others skilled in the art to understand the invention for various embodiments and with various modifications as are suited to the particular use contemplated. It is intended that the scope of the invention be defined by the following claims and their equivalents.

What is claimed is:

1. A server, accessible by a receiving device via a network, comprising:
a computer system having a processor and a network interface, the computer system being in communication with a database storing a plurality of composite video assets, each of the assets identifying a respective plurality of pictures to be displayed in sequence, and each of the assets being retrievable and transmittable by the server in response to a request,
wherein each given one of the assets carries a movie within a first rectangular region in successive pictures of the given asset and carries a plurality of temporally-arranged advertising images in a second rectangular region in the successive pictures,
wherein the first and second rectangular regions are adjacent to each other along a common edge and have equal length in a dimension of the common edge,
wherein the second rectangular region is smaller than the first rectangular region in a dimension perpendicular to the common edge,
and wherein the images in the first and second rectangular regions are composited together as a single picture in each of at least some successive pictures of the asset.

2. The server according to claim 1, further comprising a video streaming facility having a processor and a network interface, the server streaming toward a receiving device through the network interface one of the composite video assets selected in response to a user request.

3. The server according to claim 1, wherein the plurality of temporally-arranged advertising images carried in the second rectangular region in successive pictures of the given asset comprises a sequence of n different advertising images repeated m times, where n and m are integers greater than one.

4. The server according to claim 1, wherein each of the temporally-arranged advertising images is displayed in the given asset for at least five seconds before the next one of the temporally-arranged advertising images is displayed.

5. The server according to claim 1, wherein in the dimension perpendicular to the common edge, the first rectangular region is at least five times the size of the second rectangular region.

6. The server according to claim 1, wherein the first rectangular region has a standard aspect ratio, and the rectangular pictures in the given asset are all of non-standard aspect ratio.

7. The server according to claim 1, wherein the first rectangular region has an aspect ratio of 16:9, and the second rectangular region has an aspect ratio of approximately 16:1.5.

8. The server according to claim 1, wherein the second rectangular region is adjacent to the first rectangular region along a bottom edge of the first rectangular region.

9. The server according to claim 1, wherein each of the assets is encoded according to a compression standard which defines a picture,
and wherein the images in the first and second rectangular regions are composited together in each picture of the given asset in a manner that satisfies a definition in the compression standard of a single picture.

10. The server according to claim 1, wherein the number of different images portrayed in the first rectangle during a first time segment of the asset far exceeds a number of different images portrayed in the second rectangle during the same time segment.

11. The server according to claim 1, wherein all the pictures of the given asset carry the movie within the first rectangular region in successive pictures of the given asset and carry the advertising images in the second rectangular region in the successive pictures.

12. A method for streaming a composite video asset toward a receiving device via a network, for use by a computer system, comprising the steps of:
providing a primary video in which each picture has a first height and a first width;
providing a plurality of advertising images;
the computer system combining the primary video with the advertising images into a composite video asset identifying a plurality of pictures to be displayed in sequence,
wherein for at least some of the pictures in the composite video asset, each picture has first and second rectangular regions, the first rectangular region carrying the primary video in successive pictures of the composite video asset and the second rectangular region carrying in successive pictures of the composite video asset a temporal composite of the advertising images,
wherein the first and second rectangular regions are adjacent to each other along a common edge and have equal length in a dimension of the common edge,
wherein the second rectangular region is smaller than the first rectangular region in a dimension perpendicular to the common edge,
and wherein the images in the first and second rectangular regions are composited together as a single picture in each of the at least some pictures of the composite video asset; and
transmitting the composite video asset toward the receiving device via the network and a streaming video server in response to a user request.

13. The method according to claim 12, wherein the temporal composite of advertising images carried in the second rectangular region in successive pictures of the composite video asset comprises a sequence of n different advertising images repeated m times, where n and m are integers greater than one.

14. The method according to claim 12, wherein in the dimension perpendicular to the common edge, the first rectangular region is at least five times the size of the second rectangular region.

15. The method according to claim 12, wherein the first rectangular region has a standard aspect ratio, and the rectangular pictures in the given asset are all of non-standard aspect ratio.

16. The method according to claim 12, wherein the first rectangular region has an aspect ratio of 16:9, and the second rectangular region has an aspect ratio of 16:1.5.

17. The method according to claim 12, wherein the second rectangular region is adjacent to the first rectangular region along a bottom edge of the first rectangular region.

18. The method according to claim 12, further comprising the step of compressing the composite video asset according to a compression standard which defines a picture, prior to the step of streaming,
and wherein the images in the first and second rectangular regions are composited together in each picture of the composite video asset in a manner that satisfies a definition in the compression standard of a single picture.

19. The method according to claim 12, wherein the number of different images portrayed in the first rectangle during a first time segment of the asset far exceeds a number of different images portrayed in the second rectangle during the same time segment.

20. The method according to claim 12, wherein the step of combining is performed only in response to a user request for the primary video.

21. The method according to claim 12, wherein each picture of the composite video asset has the first and second rectangular regions.

22. The method according to claim 12, wherein the primary video has an aspect ratio H:Vp,
wherein the advertising images have an aspect ratio H:Va, where Va<Vp,
and wherein the step of combining comprises the steps of:
temporally compositing the plurality of advertising images to form an adtrack; and
spatially compositing the adtrack adjacent to the primary video to develop the composite video asset, the composite video asset having an aspect ratio H:(Va+Vp).

23. The method according to claim 12, wherein the primary video has an aspect ratio H:Vp,
wherein the advertising images have an aspect ratio H:Va, where Va<Vp,
and wherein the step of combining comprises the steps of:
enlarging a canvas containing each of the advertising images so as to form a corresponding plurality of second images each having aspect ratio H:Vp, with the advertising images located adjacent to a particular edge of the second pictures;
temporally compositing the plurality of second images to form an adtrack;
spatially compositing the adtrack with the primary video such that the advertising images are disposed adjacent to the primary video along the common edge, to develop a combined video having an aspect ratio H:2Vp; and
cropping the combined video to develop the composite video asset, the composite video asset having an aspect ratio H:(Va+Vp).

24. A server comprising:
a computer system having a processor and a network interface, the computer system being in communication with a streaming video source and a plurality of advertising images, the computer system spatially compositing pictures from the source with the advertising images to develop a composite video asset, the composite video asset identifying a plurality of pictures to be displayed in sequence and being transmittable by the server toward a receiving device,
wherein each given one of the assets carries a movie within a first rectangular region in successive pictures of the given asset and carries a plurality of temporally-arranged advertising images in a second rectangular region in the successive pictures,
wherein the first and second rectangular regions are adjacent to each other along a common edge and have equal length in a dimension of the common edge,
wherein the second rectangular region is smaller than the first rectangular region in a dimension perpendicular to the common edge,
and wherein the images in the first and second rectangular regions are composited together as a single picture in each of at least some successive pictures of the asset.

25. A method for streaming a composite video asset toward a receiving device via a network, for use by a computer system, comprising the steps of:
receiving a source video stream in which each picture has a first height and a first width;
providing a plurality of advertising images;
the computer system combining the source video with the advertising images into a composite video asset identifying a plurality of pictures to be displayed in sequence,
wherein for at least some of the pictures in the composite video asset, each picture has first and second rectangular regions, the first rectangular region carrying the primary video in successive pictures of the composite video asset and the second rectangular region carrying in successive pictures of the composite video asset a temporal composite of the advertising images,
wherein the first and second rectangular regions are adjacent to each other along a common edge and have equal length in a dimension of the common edge,
wherein the second rectangular region is smaller than the first rectangular region in a dimension perpendicular to the common edge,
and wherein the images in the first and second rectangular regions are composited together as a single picture in each of the at least some pictures of the composite video asset; and
transmitting the composite video asset toward the receiving device via the network and a streaming video server in response to a user request.
